(19) United States
(12) Patent Application Publication
(10) Pub. No.: US 2026/0001561 A1
(43) Pub. Date: Jan. 1, 2026

(54) MANEUVER ORIENTED TRAJECTORY PREDICTION FOR AUTONOMOUS VEHICLES

(71) Applicant: FCA US LLC, Auburn Hills, MI (US)

(72) Inventors: Carlos Barajas, Torino (IT); Stefano Sabatini, Poissy (FR); Gianoberto Gianaberto, Torrino (IT); Nicola Poerio, Torino (IT)

(21) Appl. No.: 18/757,970

(22) Filed: Jun. 28, 2024

(51) Int. Cl. B60W 50/00; B60W 60/00

(52) U.S. Cl. CPC B60W 50/0097; B60W 60/001; B60W 2554/4044; B60W 2554/4046

(57) ABSTRACT

A trajectory prediction modeling (TPM) system of a vehicle includes a set of perception sensors configured to capture a dataset indicative of a surrounding of the vehicle and a control system configured to access a trained TPM model, wherein the trained TPM model is maneuver intention-aware, execute the trained TPM model using the captured dataset to predict (i) a maneuver of a target object and (ii) a trajectory of the target object, and generate an output based on the predicted maneuver and trajectory of the target object. In some implementations, a training or calibration system is configured to train the a TPM model by auto-labeling training dataset with maneuver-intentions without input from a human annotator to obtain a labeled training dataset and then training the TPM model using the labeled training dataset to obtain the trained TPM model.

### FIELD

The present application generally relates to engine start-stop (ESS) and, more particularly, to techniques for robust control of rolling engine start-stop (RESS).

### BACKGROUND

Trajectory prediction modeling (TPM) involves analyzing a set of information (e.g., a scene in front of a vehicle) and modeling a future trajectory of a target agent (the host vehicle, another vehicle, etc.). Conventional TPM techniques have two major drawbacks. First, the predicted trajectories are all very similar (e.g., clustered together around some guessed end-point). The drawback is that if the guessed end-point is poor, then all of the predicted trajectories will also be poor. Second, there is no strict intention prediction such that TPMs can distinguish between potential future behaviors given all provided information. For example, if a left turn future trajectory is predicted, there is no way for these conventional solutions to examine what a right turn future trajectory would be given the same information. In other words, these conventional solutions do not label predicted trajectories in a manner that would be understood by a human. Accordingly, while such conventional TPM techniques do work for their intended purpose, there exists an opportunity for improvement in the relevant art.

### SUMMARY

According to one example aspect of the invention, a trajectory prediction modeling (TPM) system of a vehicle is presented. In one exemplary implementation, the TPM system comprises a set of perception sensors configured to capture a dataset indicative of a surrounding of the vehicle and a control system configured to access a trained TPM model, wherein the trained TPM model is maneuver intention-aware, execute the trained TPM model using the captured dataset to predict (i) a maneuver of a target object and (ii) a trajectory of the target object, and generate an output based on the predicted maneuver and trajectory of the target object.

In some implementations, the trained TPM model is trained using an auto-labeled training dataset. In some implementations, the auto-labeled training dataset is auto-labeled with maneuver intentions without input from a human annotator. In some implementations, at least some of the maneuver intentions indicate a predicted turn or straight driving maneuver for each object. In some implementations, at least some of the maneuver intentions indicate at least one of (i) acceleration/deceleration of the vehicle and (ii) a predicted lane change maneuver by the vehicle. In some implementations, the control system is configured to execute the trained TPM model in an urban driving environment. In some implementations, the urban driving environment includes a multi-way intersection. In some implementations, the output is a control output for the vehicle as part of an autonomous driving feature of the vehicle.

According to another example aspect of the invention, a RPM method for a vehicle is presented. In one exemplary implementation, the TPM method comprises accessing, by a control system of the vehicle, a trained TPM model that is maneuver intention-aware, executing, by the control system, the trained TPM model using a captured dataset to predict (i) a maneuver of a target object and (ii) a trajectory of the target object, wherein the captured dataset is obtained by a set of perception sensors of the vehicle and is indicative of a surrounding of the vehicle, and generating, by the control system, an output based on the predicted maneuver and trajectory of the target object.

In some implementations, the trained TPM model is trained using an auto-labeled training dataset. In some implementations, the TPM method further comprises auto-labeling a training dataset to obtain the auto-labeled training dataset with maneuver intentions without input from a human annotator. In some implementations, at least some of the maneuver intentions indicate a predicted turn or straight driving maneuver for each object. In some implementations, at least some of the maneuver intentions indicate at least one of (i) acceleration/deceleration of the vehicle and (ii) a predicted lane change maneuver by the vehicle. In some implementations, the control system is configured to execute the trained TPM model in an urban driving environment. In some implementations, the urban driving environment includes a multi-way intersection. In some implementations, the output is a control output for the vehicle as part of an autonomous driving feature of the vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example trajectory prediction modeling (TPM) system according to the principles of the present application;

FIG. 2 is a functional block diagram of an example system architecture for the TPM modeling system according to the principles of the present application; and

FIG. 3 is a flow diagram of an example TPM control method for a vehicle according to the principles of the present application.

### DESCRIPTION

As previously discussed, conventional trajectory prediction modeling (TPM) technique for vehicles, such as hierarchical vector transformer (HiVT) for multi-agent motion prediction and end-to-end trajectory prediction from dense goal sets (DenseTNT), have two major drawbacks. First, the predicted trajectories are all very similar (e.g., clustered together around some guessed end-point). The drawback is that if the guessed end-point is poor, then all of the predicted trajectories will also be poor. Second, there is no strict intention prediction such that TPMs can distinguish between potential future behaviors given all provided information. For example, if a left turn future trajectory is predicted, there is no way for these conventional solutions to examine what a right turn future trajectory would be given the same information. In other words, these conventional solutions do not label predicted trajectories in a manner that would be understood by a human. Conventional TPMs that attempt to perform intention prediction and trajectory prediction have other of drawbacks. Specifically, these models were designed and tested for usage with highway scenarios and they were not created with the intention of being used for more complex driving scenarios like busy intersections, round-abouts, and the like. These conventional TPM models are also limited in what information they can use or provide.

Three examples of these conventional TPM models are (1) maneuver-based prediction using spatio-temporal convolutional networks, (2) multimodal maneuver and trajectory prediction using transformer networks, and (3) intention-aware long horizon trajectory prediction using dual long short-term memory (LSTM) networks. The first approach limits itself to only the agents directly adjacent and directly diagonal to the target agent. Thus, this solution is only tested and verified to make lane change predictions and does not generalize to more complex driving scenarios. The second approach attempts to predict a target agent's maneuver intention over the future by dividing the future into blocks and then predicting an intention to occur at those blocks. This solution, however, is only capable of doing lane change intention predictions and it is unlikely that the model has the capacity to be generalized to the point of making additional maneuver intention predictions, like turning and lane changing for city driving, without the new generalized model being significantly more novel than the original.

The third and final approach results in an intention prediction that is not “human interpretable.” Rather, the maneuver intention is a machine-encoded structure designed to be fed into a later portion of the solution for the final trajectory prediction. Thus, there is no way to prove if this intention prediction is truly a prediction of intentions. In other words, it would not be possible for an entity to inject a desired intention into the model and get a new result back given identical information. This solution also does not provide any way for generating multiple trajectories as the model only produces a single trajectory.

In view of these drawbacks of the conventional solutions discussed above, improved TPM techniques are presented herein that (1) perform auto-labeling of maneuver intention that is human interpretable (left turn, straight, right turn, etc.) to each future trajectory and (2) training a new and improved TPM model using this labeled training data such that the TPM model is maneuver intention-aware (“MIA”). In one implementation, the TPM model is a neural network type machine learning model. The results of the TPM model are both more accurate and are also human interpretable. Such a TPM model could be particularly useful in a complex urban driving environment, whereas conventional TPM models were more focused on controlled highway driving. The more detailed outputs of the TPM model could also be leveraged by other vehicle systems, such as other autonomous driving systems/features.

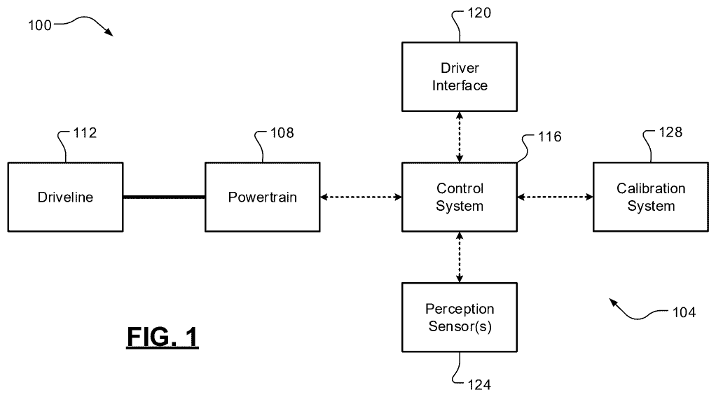

Referring now to FIG. 1, a functional block diagram of a vehicle 100 having an example TPM system 104 according to the principles of the present application is illustrated. The vehicle 100 generally comprises a powertrain 108 configured to generate and transfer drive torque to a driveline 112 for vehicle propulsion. Non-limiting examples of the components of the powertrain 108 include an internal combustion engine, one or more electric motors, and a transmission (e.g., a multi-speed automatic transmission).

A controller or control system 116 is configured to control operation of the vehicle 100, including primarily controlling the powertrain 108 to generate a desired amount of drive torque to satisfy a driver torque request (e.g., received via a driver interface 120, such as an accelerator pedal). The TPM system 104 comprises the control system 116, a set of perception sensors 124, and, in some implementations, an external or separate calibration system 128 (e.g., another computing system). Non-limiting examples of the set of perception sensors 124 include an HD maps system, cameras (e.g., a front-facing camera for capturing a scene in front of the vehicle 100), radio detection and ranging (RADAR) sensors, and light detection and ranging (LIDAR) sensors. The TPM system 104 is configured to perform the TPM techniques of the present application, which will now be discussed in greater detail.

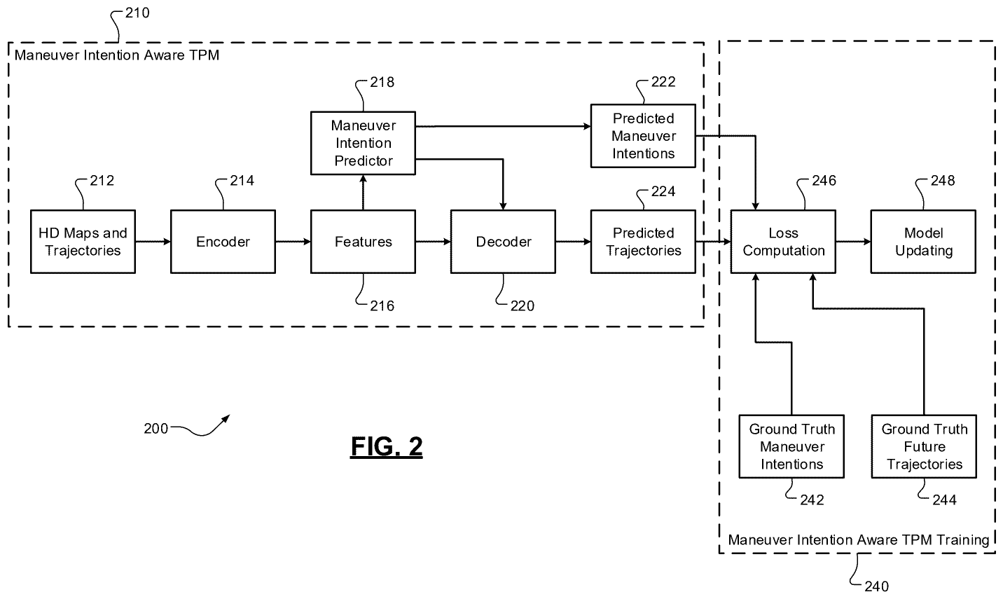

Referring now to FIG. 2, an example system architecture 200 for the control system 116 (the TPM system 104) according to some implementations of the present application is illustrated. It will be appreciated that this is merely one example system configuration and that other suitable system architectures could be utilized. The system architecture 200 can be generally divided into two sections: (1) a maneuver intention-aware (MIA) TPM 210 and (2) MIA TPM training 240. Initially, HD maps and object trajectories (or other suitable data that can be converted to HD maps and trajectories) are collected at 212. Next, an encoder 214 is fed the collected data and outputs a collection of features 216 which can be used as input to a decoder 220. A maneuver-intention predictor 218 utilizes a machine learning model (e.g., a neural network based model) to determine or predicts maneuver intentions of objects based on the plurality of features 216. The plurality of features 216 are also fed to a decoder 220, which determines or predicts trajectories of the objects based on the output of the decoder 220. For TPMs, the decoder 220 is most likely a neural network.

The final results of the MIA TPM 210 (output by the maneuver intention predictor 218 and the decoder 220) are the predicted maneuver intentions and predicted trajectories of objects. As mentioned above, the maneuver intention predictor 218 is a machine learning algorithm, or even a collection of machine learning algorithms, that determines the probability of each maneuver intention within each maneuver intention set. If there are two maneuver sets then the maneuver intention predictor 218 would produce two sets of probabilities for the input features. The maneuver intention predictor 218 may also predict the most probable maneuver intention for each maneuver intention set rather than the probabilities.

While a neural network based model is most likely to be utilized, it will be appreciated that any classical classification machine learning algorithm could also be used instead of a neural network. For predicting class probabilities for each maneuver set one can use either of the following options: (i) a single neural network or any classical classification algorithm for each maneuver intention set, or (ii) a wide neural network that makes computes all probabilities for each maneuver intention set simultaneously or any classical multi-class multi-label classification algorithm.

For training purposes, the machine learning model(s) utilized by the maneuver-intention predictor 218 can be updated to improve its performance/accuracy. As shown in the MIA TPM training 240 section, ground truth maneuver intentions 242 and future trajectories 244 are fed into a loss computation block 246 (along with the predicted maneuver intentions and trajectories from the MIA TPM 210) and the losses or differences between the predictions and the ground truths is utilized for model updating 248. These ground truths are determined by the process of auto-labeling of a training dataset. Auto-labeling is the process through which we automatically assign a maneuver intention from each maneuver intention set to a target object or agent given the future trajectory and scene information. The term “label” as used herein refers to a qualitative motion description that can be programmatically and deterministically computed and then broken down in a collection of maneuver intentions.

In one implementation, three maneuver intention sets are devised: (1) turning (lateral maneuvers: turn left, go straight, turn right), (2) velocity changes (longitudinal: acceleration, no change, deceleration), and (3) lane changes (left, none, right). Each of these maneuver intention sets has their own set of rules for determining a target agents assigned maneuver intention. In this way, we can create qualitative labels (which are human interpretable) using quantitative techniques (programmatically assignable). We then can use these qualitative labels to train a TPM to generate trajectories based on qualitative information. For example, vehicle deceleration could be indicative of an upcoming turn maneuver, whereas maintaining or increasing the vehicle's speed could be indicative of the vehicle continuing straight and/or performing a lane change. It will be appreciated, however, that these are merely examples. After the data has been auto-labelled, the TPM model can then be trained to be maneuver intention-aware by using the maneuver intention information, HD Maps, and relevant trajectories (e.g., usually the trajectories for all agents). In general, the MIA TPM has the same flow regardless of whether it is being trained or is being used post-deployment, which will now be discussed in greater detail below.

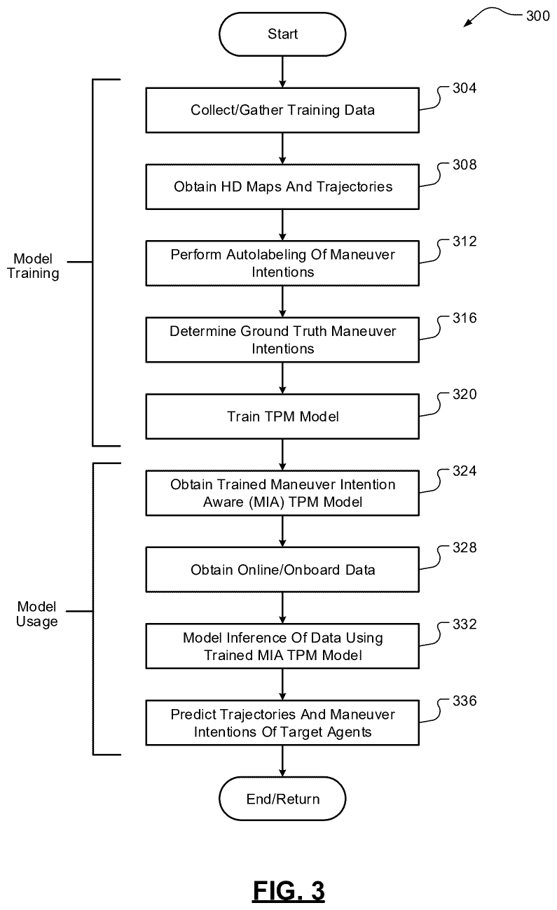

Referring now to FIG. 3, a flow diagram of an example TPM method 300 for a vehicle according to the principles of the present application is illustrated. While the method 300 specifically references the vehicle 100 and its components, it will be appreciated that the method 300 could be applicable to any suitably configured vehicle 100. At 304, the calibration system 128 (the TPM system 104) collects or gathers training data for training the MIA TPM. From this training data, HD maps and trajectories of objects are obtained at 308 (i.e., the training data can be either HD maps and trajectories or another suitable form of data that can be converted to HD maps and trajectories). At 312, auto-labeling of maneuver intentions of the objects is performed. At 316, ground truth maneuver intentions are determined for comparison to the predictions and improvement of the model performance/accuracy. At 320, the TPM is trained and updated and the trained MIA TPM is obtained at 324 (e.g., and storied in a local memory for subsequent access). This could involve uploading the trained MIA TPM from the calibration system 128 to the control system 116. At 328, online or on-board data is collected from the plurality of perception sensors 124. At 332, model inference of the collected data using the trained MIA TPM is performed to predict trajectories and maneuver intentions of select/target objects at 336. The method 300 then ends or returns to 328 for continued object monitoring.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A trajectory prediction modeling (TPM) system of a vehicle, the TPM system comprising:
a set of perception sensors configured to capture a dataset indicative of a surrounding of the vehicle; and
a control system configured to:
access a trained TPM model, wherein the trained TPM model is maneuver intention-aware;
execute the trained TPM model using the captured dataset to predict (i) a maneuver of a target object and (ii) a trajectory of the target object; and
generate an output based on the predicted maneuver and trajectory of the target object.

2. The TPM system of claim 1, wherein the trained TPM model is trained using an auto-labeled training dataset.

3. The TPM system of claim 2, wherein the auto-labeled training dataset is auto-labeled with maneuver intentions without input from a human annotator.

4. The TPM system of claim 3, wherein at least some of the maneuver intentions indicate a predicted turn or straight driving maneuver for each object.

5. The TPM system of claim 4, wherein at least some of the maneuver intentions indicate at least one of (i) acceleration/deceleration of the vehicle and (ii) a predicted lane change maneuver by the vehicle.

6. The TPM system of claim 1, wherein the control system is configured to execute the trained TPM model in an urban driving environment.

7. The TPM system of claim 6, wherein the urban driving environment includes a multi-way intersection.

8. The TPM system of claim 1, wherein the output is a control output for the vehicle as part of an autonomous driving feature of the vehicle.

9. A trajectory prediction modeling (TPM) method for a vehicle, the TPM method comprising:
accessing, by a control system of the vehicle, a trained TPM model that is maneuver intention-aware;
executing, by the control system, the trained TPM model using a captured dataset to predict (i) a maneuver of a target object and (ii) a trajectory of the target object, wherein the captured dataset is obtained by a set of perception sensors of the vehicle and is indicative of a surrounding of the vehicle; and
generating, by the control system, an output based on the predicted maneuver and trajectory of the target object.

10. The TPM method of claim 9, wherein the trained TPM model is trained using an auto-labeled training dataset.

11. The TPM method of claim 10, further comprising auto-labeling a training dataset to obtain the auto-labeled training dataset with maneuver intentions without input from a human annotator.

12. The TPM method of claim 11, wherein at least some of the maneuver intentions indicate a predicted turn or straight driving maneuver for each object.

13. The TPM method of claim 12, wherein at least some of the maneuver intentions indicate at least one of (i) acceleration/deceleration of the vehicle and (ii) a predicted lane change maneuver by the vehicle.

14. The TPM method of claim 9, wherein the control system is configured to execute the trained TPM model in an urban driving environment.

15. The TPM method of claim 14, wherein the urban driving environment includes a multi-way intersection.

16. The TPM method of claim 9, wherein the output is a control output for the vehicle as part of an autonomous driving feature of the vehicle.
